(19) United States
(12) Patent Application Publication
(10) Pub. No.: US 2004/0231561 A1
(43) Pub. Date: Nov. 25, 2004

(54) Inherently colored polyurea and polyurethane

(76) Inventors: Bansi Lal Kaul, Biel-Benken (CH); Jean-Christophe Graciet, Huningue (FR); Nikolay N. Barashkov, Hercules, CA (US); Thomas C. Molloy, Benicia, CA (US); Ronghua Liu, Pleasant Hill, CA (US)

Correspondence Address: CLARIANT CORPORATION, INTELLECTUAL PROPERTY DEPARTMENT, 4000 MONROE ROAD, CHARLOTTE, NC, 28205, US

(21) Appl. No.: 10/483,103

(22) PCT Filed: Jul. 8, 2002
(86) PCT No.: PCT/IB02/02684

(30) Foreign Application Priority Data
Jul. 9, 2001 (GB) 0116678.4

(51) Int. Cl. C08K 5/00

(52) U.S. Cl. 106/493

(57) ABSTRACT

This invention relates to copolymer compositions having pigment like properties, comprising a fluorescent or non-fluorescent dye attached to a polyurea or polyurethane chain by a spacer.

The invention also provides for new monofunctional dye monomers comprising an isocyanate group attached to a dye moiety by a spacer comprising a urea or urethane group.

The polymer pigments provide excellent properties, especially high temperature stability and easy applicability as colorant in different standard polymers.

This invention relates to a composition to form inherently colored polyurea or polyurethane, in the following both abreviated as PU, having pigment like properties, comprising a fluorescent or non-fluorescent dye attached to at least one isocyanate moiety by a spacer. Further the invention relates to a polycondensation process for said PU composition to form polymer particles having pigment like properties. The invention also relates to the respective new dye monomers as well as to a process for their preparation.

Articles containing colorants are known to loose their color when exposed to solar radiation for extended times. In particular, fluorescent colorants degrade more quickly than conventional colorants, often turning colorless on exposure to daily solar radiation within days or months.

In conventional fluorescent and non-fluorescent polymer pigments, the polymer component of the pigment typically acts as a carrier or solvent for the dye. The polymer and the dye associate in a “solid state solution”. The conventional dye carriers have varied compositions which are selected depending upon the dye and the use of the pigment. For example, U.S. Pat. No. 3,741,907 (Beyerlin) discloses pigments essentially consisting of an isocyanate resin and fluorescent coloring matter uniformly dispersed therein. The fluorescent coloring matter is not functionalized to be covalently bond to the resin, it is dispersed in the polymerization mixture prior to or during the formation of the resin.

Colorants not covalently bond in a polymer matrix tend to agglomerate and to crystalize leading to inhomogenous distribution of colorants within the matrix. Fluorescent colorants in particular often loose their fluorescent properties by agglomeration of fluorescent sites (quenching). Furthermore with non covalently bond colorants, fading or bleading of the colorant occurs.

Generally there are three different ways to covalently attach a dye molecule to a polymer backbone. The first is grafting the dye molecule onto a reactive side group of the polymer backbone. The second way is capping the ends of a polymer chain with a monofunctional dye molecule reactive to the polymer chain. The third way is reacting a difunctional dye monomer together with other monomers into the polymer chain.

H. Wang, I. Tzun, Journal of Applied Polymer Science, 73, 245-253 (1999) disclose the grafting of a dye molecule, modified by reaction with an epichlorhydrin coupling agent, onto a PU polymer with hydroxyl side groups. The dye is attached after the polyreaction of the PU.

WO 99/50361 discloses the chain extension of a PU prepolymer with a colorant. In particular the colorant is difunctional either with two functional groups reactive to isocyanate, e.g. hydroxyl or amin, or two isocyanate groups. In the first step of a two step process a PU prepolymer is synthesised. In the second step the polymer chain is extended with the functionalized dye molecules. The examples disclose two diamine functionalized dye molecules being reacted to PU polymers of a molecular weight (M_{w}) of from 7000 to 9000. Preferred dye groups are azo groups, anthraquinone groups phthalocyanine groups and triphendioxazine groups.

U.S. Pat. No. 6,103,006 (Di Pietro) describes light fast polymer pigments containing a fluorescent dye reacted into the polymer backbone of polyamide, polyamide ester or polyester. To form these polycondensation type polymers, at least one monomer has to have a carboxylic acid group to either form an amide bond (with an amine group of a second monomer) or an ester bond (with a hydroxy group of a second monomer). As a preferred fluorescent dye monomer the benzothioxanthene dicarboxylic anhydride is described.

WO 98/26754 discloses a cosmetic composition containing a coloring agent obtained by co-polycondensation of a diisocyanate with a diol and a colorant monomer having at least two hydroxyl groups. The formed polymer is a polyurethane.

The french patent application FR 2237922 discloses the coloration of polyurea or polyurethane by co-polycondensation of perylene type colorants either having two terminal hydroxyl groups or two terminal amine groups. The hydroxyl or amine groups are separated from the dye moiety by a C₁₋₆ alkyl spacer.

The German patent application DE 2426180 A1 discloses dye monomers to be co-reacted into a PU. The dye monomers have at least one group reactive to isocyanate attached to a dye moiety by a “spacer”. The “spacer” is either a direct bond, oxygen, an amine or an amide group. The reactive group is further defined as being a very specific group having at least two hydroxy groups. A preferred embodiment of this specific group is of the general formula given below, with R and R′ independently being hydrogen, C₁₋₄ alkyl or further C₁₋₆-ω-hydroxyalkyl groups.

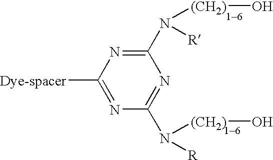

One objective of the present invention is to provide new dye monomers to be co-reacted into a PU chain, having one or two diisocyanate groups as reactive groups.

Another objective is to provide such monomers which are easily accessible by a standardized reaction path, allowing a broad variation of dye moieties and spacer groups without significantly changing the reaction scheme.

A further objective of the present invention is to provide a composition to form inherently colored PU with pigment like properties being easily applicable in the coloration of standard polymers.

These objectives are achieved by a composition comprising a new dye monomer to be reacted to or to be incorporated into the backbone of a PU chain. In the new dye monomer the dye moiety is separated from the isocyanate moiety or isocyanate moieties by a spacer containing a urea or urethane group.

The dye monomer is of the general formula (I)

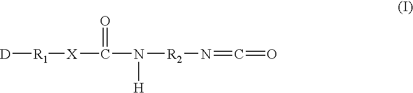

in which

R₁ is C₁₋₁₂ alkylen, C₆₋₁₀ arylen, (C₆₋₁₀) aryl-(C₁₋₆) alkylen or (C₁₋₆) alkyl-(C₆₋₁₀) arylen, —(C₁₋₆alkylen-O—)ₙ—C₁₋₆alkylen- with n being a number from 0 to 6; the alkylen and/or arylen radicals optionally being substituted by hydroxyl, C₁₋₆ alkyl, C₁₋₆ alkoxyl, C₆₋₁₀ aryloxy or halogen,

X is oxygen or NR′ with R′ being hydrogen, C₁₋₆ alkyl, C₆₋₁₀ aryl, (C₆₋₁₀) aryl-(C₁₋₆) alkyl or (C₁₋₆) alkyl-(C₆₋₁₀) aryl, the alkyl and/or aryl radicals optionally being substituted by hydroxyl, C₁₋₆ alkoxyl, C₆₋₁₀ aryloxy or halogen,

R₂ is C₁₋₁₂ alkylen, C₅₋₆ cycloalkylen, C₆₋₁₀ arylen, (C₆₋₁₀) aryl-(C₁₋₆) alkylen or (C₁₋₆) alkyl-(C₆₋₁₀) arylen, —(C₁₋₆alkylen-O—)ₙ—C₁₋₆alkylen- with n being a number from 0 to 6; the alkylen, cycloalkylene and/or arylen radicals optionally being substituted by hydroxyl, C₁₋₆ alkyl, C₁₋₆ alkoxyl, C₆₋₁₀ aryloxy or halogen, and

D is a dye moiety of the general formulae (II) to (VI)

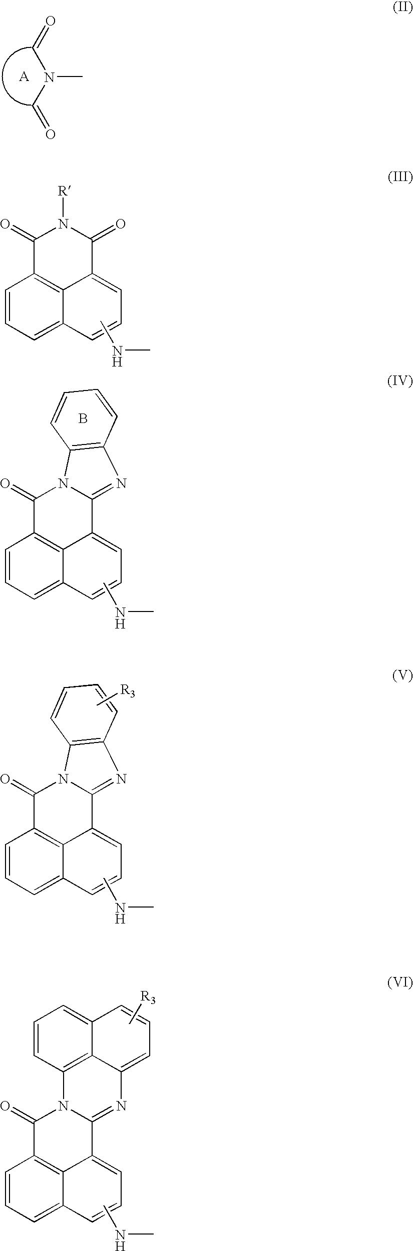

with A being a substituted or unsubstituted fused aromatic or heterocyclic ring system, preferably of the general formula (IIa), (IIb) or (IIc)

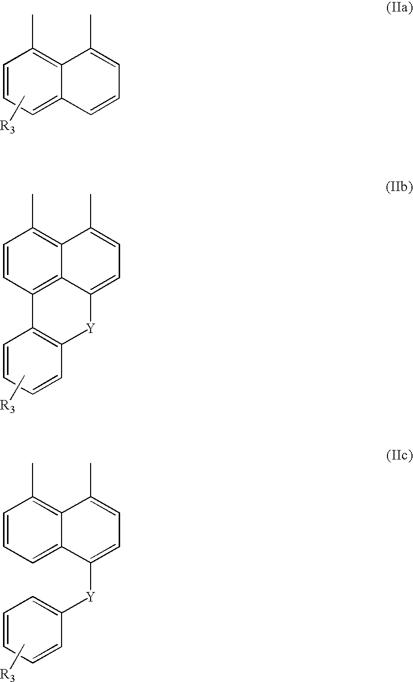

with R₃ being hydrogen, halogen, NR₄R₅, R₅O or R₅S, with R₄ being hydrogen, C₁₋₆ alkyl, C₆₋₁₀ aryl, (C₆₋₁₀) aryl-(C₁₋₆) alkyl or (C₁₋₆) alkyl-(C₆₋₁₀) aryl, the alkyl and/or aryl radicals optionally being substituted by hydroxyl, C₁₋₆ alkoxyl, C₆₋₁₀ aryloxy or halogen; R₅ being C₁₋₆ alkyl, C₆₋₁₀ aryl, (C₆₋₁₀) aryl-(C₁₋₆) alkyl or (C₁₋₆) alkyl-(C₆₋₁₀) aryl, the alkyl and/or aryl radicals optionally being substituted by hydroxyl, C₁₋₆ alkoxyl, C₆₋₁₀ aryloxy or halogen; and Y being sulphur, oxygen or NR₄, with R₄ having the meaning given above,

the Ring B is annelated in 3,4-position with a group of the formula —NR₆(CO)ₘ—NR₇— or —O—CO—NR₆—, m is 1 or 2, R₆ and R₇ are independently hydrogen, C₁₋₆ alkyl, C₆₋₁₀ aryl, (C₆₋₁₀) aryl-(C₁₋₆)alkyl or (C₁₋₆)alkyl-(C₆₋₁₀)aryl, the alkyl and/or aryl radicals optionally being substituted by amino, C₁₋₆ alkylamino, C₆₋₁₀ cycloalkylamino, hydroxyl, C₁₋₆ alkoxyl, C₆₋₁₀ aryloxy or halogen.

Especially preferred dye monomers are those of the general formula (II) where A is of the general formula (IIb), with Y being sulphur and R₃ being hydrogen and those of the general formula (V) with R₃ being hydrogen.

Preferred spacer R₁ and R₂ independently are C₂₋₆ alkylen, C₆ cycloalkylen, —(C₁₋₆alkylen-O—)ₙ—C₁₋₆-alkylen- with n being 1, 2 or 3 and C₆ arylen optionally substituted. Most preferably R₁ and R₂ independently are C₂, C₃ or C₆ alkylen, -(ethylene-O—)ₙ-ethylene- with n being 2.

X preferably is oxygen or NR′ with R′ being hydrogen or methyl.

The preferred content of the polymerizable monomer in a PU composition according to the invention is from 0.01 to 10, more preferably from 1 to 5 and most preferably between 2 and 3 percent by weight based on the total weight of the PU composition.

The intermediates for the synthesis of the dye monomers of formula (I) with D being of one of the formulae (II) are obtained by the condensation of the dicarboxylic anhydride of the respective dye moiety with an aminoalcohol or a diamine comprising the respective spacer according to the general formula (VII) in a polar aprotic solvent according to the reaction scheme:

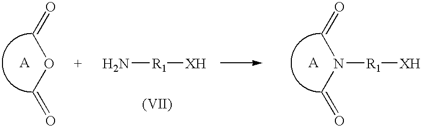

wherein A, R₁, and X are as defined above.

The intermediates for the synthesis of the dye monomers of formula (I) with D being of one of the formulae (III) to (VI) are obtained by the reaction of the dye moiety functionalized with a leaving group (L), e.g. chlorine or bromine, with an amino alcohol or diamine comprising the respective spacer according to the general formula (VII).

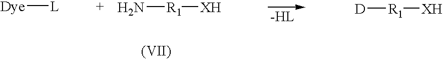

In each case, the hydroxy or amino group on the free end of the spacer is further functionalized with diisocyanate compounds of the general formula (VIII) as indicated below. The final product is obtained in high yield.

The general synthesis is shown in the scheme below

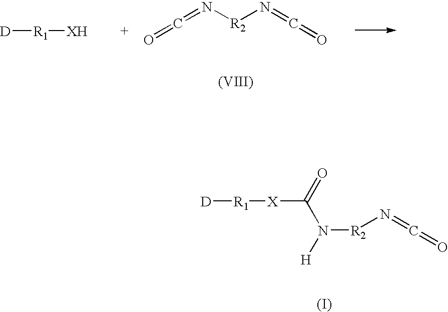

wherein D, R₁, R₂ and X are as defined above.

The polycondensation of the dye monomers according to the invention is usually carried out as a suspension (or mini emulsion) polymerisation in water, with the reaction mixture comprising diamine of the general formula (IX) as indicated below and new isocyanate functionalized dye monomer of the general formula (I) and optionally a further diisocyanate of the general formula (VIII).

The general synthesis for the monofunctionalized monomers being reacted into a polyurea is shown in the scheme below.

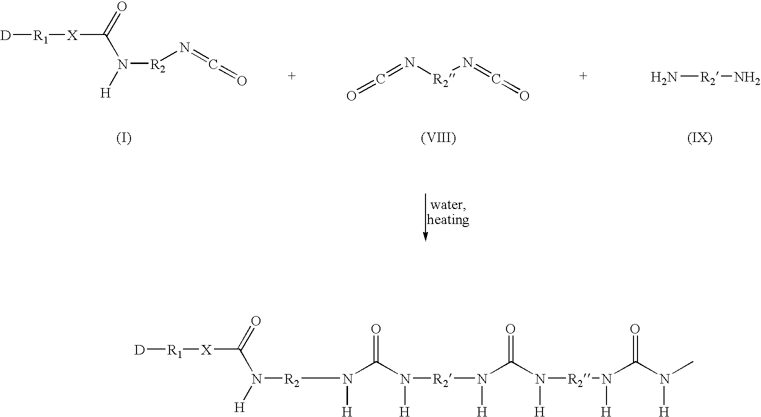

wherein D, R₁, R₂ and X are defined as above and R₂′ and R₂″ independently are C₁₋₁₂ alkylen, C₅₋₆ cycloalkylen, C₆₋₁₀ arylen, (C₆₋₁₀) aryl-(C₁₋₆) alkylen or (C₁₋₆) alkyl-(C₆₋₁₀) arylen, -(C₁₋₆-alkylen-O—)ₙ—C₁₋₆alkylen- with n being a number from 0 to 6; the alkylen, cycloalkylene and/or arylen radicals optionally being substituted by hydroxyl, C₁₋₆ alkyl, C₁₋₆ alkoxyl, C₆₋₁₀ aryloxy or halogen.

The general synthesis for the monofunctionalized monomers being reacted into a polyurethane is shown in the scheme below.

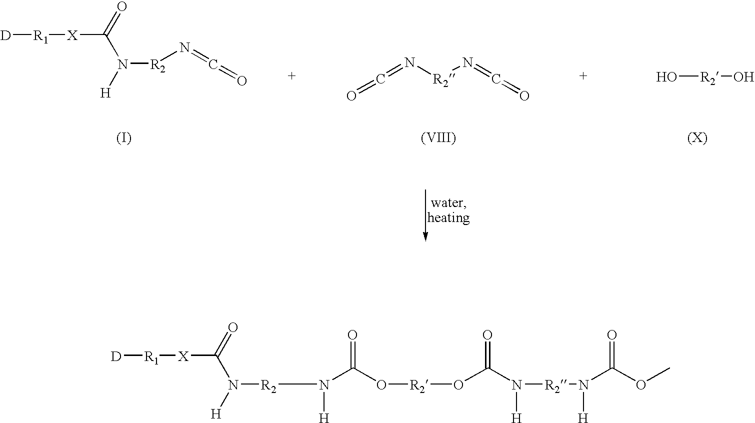

wherein D, R₁, R₂, R₂′ R₂″ and X are defined as above.

Preferred diisocyanates are, for example, 1,4-tetramethylene diisocyanate, 1,6-hexamethylenediisocyanate, 1-isocyanato-3-isocyanatoomethyl-3,5,5-trimethyl-cyclohexane (also referred to as isophoronediisocyanate), 4,4′-diisocyanato-dicyclohexylmethane, phenylene-1,4-diisocyanate, 2,4- and 2,6-tolylene diisocyanate, naphthylene-1,5-diisocyanate, 3,3′-bitolylene4,4′-diisocyanate, diphenylmathane-4,4′-diisocyanate, 3,3′-dimethyldiphenylmethane4,4′-diisocyanate, metaphenylene diisocyanate, 2,4-tolylene diisocyanate dimer and dianisidine diisocyanate.

Most preferred diisocyanates (VIII) are C₆₋₁₂ alkylen diisocyanates, toluylene-2,4-diisocyanate (VIIIa) or 1-isocyanato-3-isocyanatoomethyl-3,5,5-trimethylcyclohexane (also referred to as isophoronediisocyanate) (VIIIb).

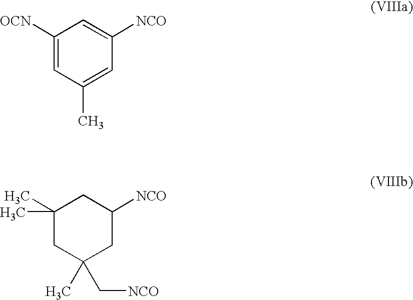

Preferred diamines (IX) are C₆₋₁₂ alkylen diamine, C₅₋₆ cycloalkylen diamine, toluylene-2,4-diamine (IXa) or 1-amino-3-aminomethyl-3,5,5-trimethylcyclohexane, also referred to as isophoronediamine (IXb).

Most preferred diamines (IX) are, for example, 1,2-ethylenediamine, 1,4-tetramethylene diamine, 1,6-hexamethylene diamine, trimethylhexamethylene diamine, 1,4-diaminocyclohexane, toluylene-2,4-diamine (IXa) or 1-amino-3-aminomethyl-3,5,5-trimethylcyclohexane, also referred to as isophoronediamine (IXb).

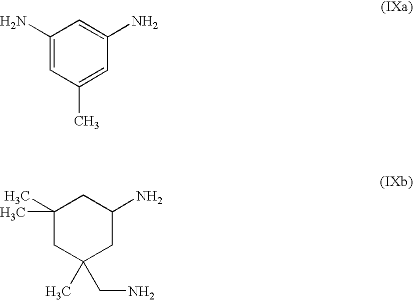

Most preferred diols (X) are C₆₋₁₂ alkylendiols, toluylene-2,4-diol (Xa) or 1-hydroxy-3-hydroxymethyl-3,5,5-trimethylcyclohexane (also referred to as isophoronediol) (Xb).

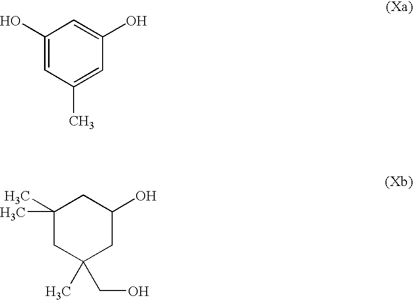

The reaction temperature is in the range from 0 to 100° C., preferably around 80° C.

Dispersing agent or surfactants may be present in an amount from 0 to 20%, preferably around 5% by weight of the reaction mixture.

The obtained copolymer particles having pigment like properties (also referred to as copolymer pigments) form a bright colored powder, said product essentially consisting of non-spherical particles having broad particle size distribution and irregular shape (if no surfactants are used) or mainly having substantially uniform size spherical microparticles having mainly size from 1 to 5 microns (one or several surfactants are used).

The obtained copolymer particles having pigment like properties may be finished or growned by methods well known in the art.

The copolymer pigments according to the invention are suitable for the mass pigmentation of substrates including synthetic polymers, synthetic resins and regenerated fibers optionally in the presence of solvents. These substrates more particularly include oil, water and solvent based surface coatings, polyester spinning melts, polyethylene, polystyrene and polyvinyl chloride melts, polymethacrylate and polymethylmethacrylate melts, polyuethane masses, rubber and synthetic leather. Furthermore, the pigments can be used in the manufacture of printing inks, for the mass coloration of paper and for coating and printing textiles.

The copolymer pigments according to the invention are also suitable as colorants in electrophotographic toners and developers, such as one- or two-component powder toners (also called one- or two-component developers), magnetic toners, liquid toners, polymerization toners and specialty toners.

Typical toner binders are addition polymerization, polyaddition and polycondensation resins, such as styrene, styrene-acrylate, styrene-butadiene, acrylate, polyester and phenol-epoxy resins, polysulphones, polyurethanes, individually or in combination, and also polyethylene and polypropylene, which may comprise further constituents, such as charge control agents, waxes or flow assistants, or may be modified subsequently with these additives.

The copolymer pigments according to the invention are suitable, furthermore, as colorants in powders and powder coating materials, especially in triboelectrically or electrokinetically sprayable powder coating materials which are used for the surface coating of articles made, for example, from metal, wood, plastic, glass, ceramic, concrete, textile material, paper or rubber.

Powder coating resins that are typically employed are epoxy resins, carboxyl- and hydroxyl-containing polyester resins, polyurethane resins and acrylic resins, together with customary hardeners. Combinations of resins are also used. For example, epoxy resins are frequently employed in combination with carboxyl- and hydroxyl-containing polyester resins. Typical hardener components (as a function of the resin system) are, for example, acid anhydrides, imidazoles and also dicyanodiamide and its derivatives, blocked isocyanates, bisacylurethanes, phenolic and melamine resins, triglycidyl isocyanurates, oxazolines and dicarboxylic acids.

In addition, the copolymer pigments according to the invention are suitable as colorants in ink-jet inks, both aqueous and non-aqueous, and in those inks, which operate in accordance with the hot-melt process.

The following examples illustrate the invention. Unless otherwise specified, parts and percentages used in the examples are on a weight to weight basis.

### EXAMPLES

1) Synthesis of polymerizable monomers

### Example 1

### Synthesis of HY6CN-IC6 monomer

0.5 part of (6-aminohexamethylene)-benzothioxanthene dicarboxydiimide is added portionwise to a mixture of 50 parts of hexamethylenediisocyanate and 10 parts of acetone, firstly heated to 80° C. After reaction completion, the resulting fluorescent yellow solution is used as it is, without isolation in next step of copolymerization.

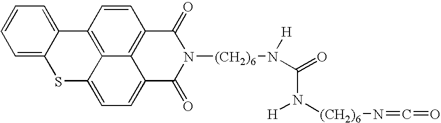

### Example 2

### Synthesis of HY2CO-IC6 monomer

0.5 parts of (2-hydroxyethyl)-benzothioxanthene dicarboxydiimide is added portionwise to a mixture of 50 parts of hexamethylenediisocyanate and 10 parts of acetone, firstly heated to 80° C. After reaction completion, the resulting fluorescent yellow solution is used as it is, without isolation in next step of copolymerization.

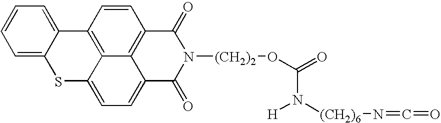

### Example 3

### Synthesis of HY6CN-ICTO monomer

0.5 part of (6-aminohexamethylene)-benzothioxanthene dicarboxydiimide is added portionwise to a mixture of 50 parts of Toluylene-2,4-diisocyanate and 10 parts of acetone, firstly heated to 80° C. After reaction completion, the resulting fluorescent yellow-orange solution is used as it is, without isolation in next step of copolymerization.

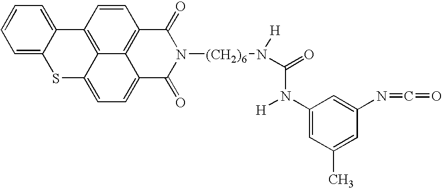

### Example 4

### Synthesis of HY-E3N-IC6 monomer

0.5 parts of (aminoethyl-bis-ethyleneoxy)-benzothioxanthene dicarboxydiimide is added portionwise to a mixture of 50 parts of hexamethylenediisocyanate and 10 parts of acetone, firstly heated to 80° C. After reaction completion, the resulting fluorescent yellow-orange solution is used as it is, without isolation in next step of copolymerization.

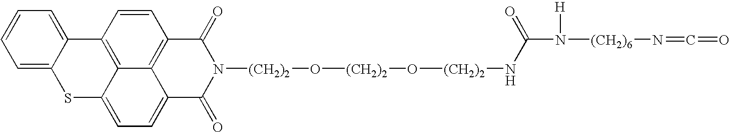

### Example 5

### Synthesis of Napht-3CN-IC6 monomer

4-bromonaphtahlic anhydride (10 parts) is suspended in 40 parts of N-methylpyrrolidone and 4 parts of 1,2-diaminobenzene are added under nitrogen atmosphere. The reaction mixture is stirred at 140° C. until reaction is completed. After cooling, product is isolated by filtration and washed with methanol and dried. Desired product is obtained as a red powder in 85% yield. 5 parts of obtained product are suspended in 38 parts of N-methylamino-propylamine and heated at 80° C. under nitrogen atmosphere until reaction completes. The reaction mixture is then poured into 100 parts of hot water and then filtered and washed with water until no amine left in presscake. After drying, final colorant is obtained in 90% as a red powder.

0.5 part of previously obtained dye is added portion wise to a mixture of.50 parts of hexamethylenediisocyanate firstly heated to 80° C. After reaction completion, the resulting bright red solution is used as it is, without isolation in next step of copolymerization.

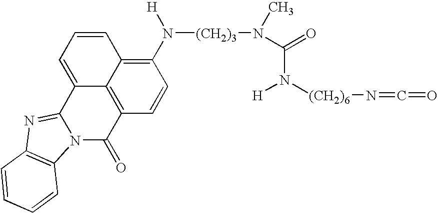

### Example 6

### Synthesis of Napht-2CO-IC6 monomer

4-bromonaphtahlic anhydride (10 parts) is suspended in 40 parts of N-methylpyrrolidone and 4 parts of 1,2-diaminobenzene are added under nitrogen atmosphere. The reaction mixture is stirred at 140° C. until reaction is completed. After cooling, product is isolated by filtration and washed with methanol and dried. Desired product is obtained as a red powder in 85% yield. 5 parts of obtained product are suspended in 38 parts of 2-hydroxylamine and heated at 80° C. under nitrogen atmosphere until reaction completes. The reaction mixture is then poured into 100 parts of hot water and then filtered and washed with water until no amine left in presscake. After drying, final colorant is obtained in 85% as a red powder.

0.5 part of previously obtained dye is added portion wise to a mixture of 50 parts of hexamethylenediisocyanate firstly heated to 80° C. After reaction completion, the resulting bright red solution is used as it is, without isolation in next step of copolymerization.

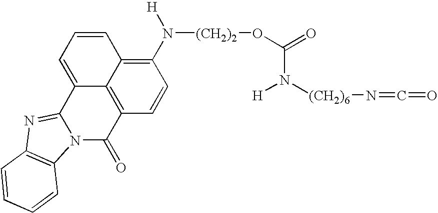

2) Synthesis of co-polymers including colored monomers

### Example 7

### Synthesis of PU-co-HY6CN-IC6 Copolymer

1—Copolymerization

A mixture of 50 parts of hexamethylenediamine and 250 parts of water in presence of 5 parts of dispersing agent is firstly heated and kept at 80° C. HY6CN-IC6 monomer (of example 1) fluorescent yellow solution is then added to this solution under vigorous stirring, over 1 hour at this temperature. Immediately after addition begins, a yellow product starts to precipitate. After end of addition, the yellow suspension is stirred at 80° C. for 3 additional hours.

2—Purification

The precipitate was filtered and washed with hot water until no alkyldiamine is detectable in filtrate. Resulting presscake is suction-dried on Büchner. Presence of unreacted dye is checked in various organic solvents. No product was extractable from copolymer (colorless supernatants). The yellow powder was then dried in a vacuum oven at 80° C. overnight.

3—Properties

Shape and colour:50 g pale yellow powder

Solubility:insoluble in the following organic solvents:methanol, acetone, THF, DMF, NMP, DMSO, chloroform, dichlorobenzene.

DSC:peaks at 286° C. and 365° C.

Composition:according to the monomer feed composition and the reactivity ratios of the monomers, the copolymer composition was calculated from the copolymer composition equation. It should contain 1% of HY6CN-IC6 (weight). However, the copolymer is actually a mixture of PU-co-HY6CN-IC6 copolymers with different copolymer compositions. With the increase of the conversion during the polymerization, the more reactive monomer HY6CN-IC6 was consumed. This results in a continual shift of the monomer feed composition to lower HY6CN-IC6 content, and also a continual shift in copolymer composition. The calculated copolymer composition can only be obtained at low conversions of polymerization (<10%) where the compositional drift is negligible.

### Example 8

### Synthesis of PU-co-HY2CO-IC6 copolymer

1—Copolymerization

A mixture of 50 parts of hexamethylenediamine and 250 parts of water in presence of 5 parts of dispersing agent is firstly heated and kept at 80° C. HY2CO-IC6 monomer (of example 2) fluorescent yellow solution is then added to this solution under vigorous stirring, over 1 hour at this temperature. Immediately after addition begins, a bright yellow product starts to precipitate. After end of addition, the yellow suspension is stirred at 80° C. for 3 additional hours.

2—Purification

The precipitate was filtered and washed with hot water until no alkyldiamine is detectable in filtrate. Resulting presscake is suction-dried on Büchner. Presence of unreacted dye was checked in various organic solvents. Unreacted product was extractable from copolymer (colorless supernatants). The yellow powder was then dried in a vacuum oven at 80° C. overnight. Unreacted dye monomer is then extracted in a Soxhlet apparatus by boiling in ethanol for 12 hours. After drying in oven at 80° C., loss of dye monomer is evaluated to <1% of used dye monomer.

3—Properties

Shape and colour:50 g bright yellow powder

Solubility:insoluble in the following organic solvents:methanol, acetone, THF, DMF, NMP, DMSO, chloroform, dichlorobenzene.

DSC:peaks at 292° C. and 362° C.

Composition:according to the monomer feed composition and the reactivity ratios of the monomers, the copolymer composition was calculated from the copolymer composition equation. It should 1% of HY2CO-IC6 (weight). However, the copolymer is actually a mixture of PS-co-HY2CO-IC6 copolymners with different copolymer compositions. With the increase of the conversion during the polymerization, the more reactive monomer HY2MA was consumed. This results in a continual shift of the monomer feed composition to lower HY2CO-IC6 content, and also a continual shift in copolymer composition. The calculated copolymer composition can only be obtained at low conversions of polymerization (<10%) where the compositional drift is negligible.

### Example 9

### Synthesis of PU-co-HY6CN-ICTO copolymer

1—Copolymerization

A mixture of 50 parts of hexamethylenediamine and 250 parts of water in presence of 5 parts of dispersing agent is firstly heated and kept at 80° C. HY6CN-ICTO monomer (of example 3) fluorescent yellow suspension is then added to this solution under vigorous stirring, over 1 hour at this temperature. Immediately after addition begins, a bright orange product starts to precipitate. After end of addition, the orange suspension is stirred at 80° C. for 3 additional hours.

2—Purification

The precipitate was filtered and washed with hot water until no alkyldiamine is detectable in filtrate. Resulting presscake is suction-dried on Büchner. Presence of unreacted dye was checked using TLC technics. No unreacted product was detectable in copolymer. The yellow powder was then dried in a vacuum oven at 80° C. overnight.

3—Properties

Shape and colour:50 g bright orange powder

Solubility:soluble in the following organic solvents:DMF, NMP, insoluble in the following organic solvents:ethanol, o-dichlorbenzene.

DSC:peaks at 190° C. and 315° C.

Composition:according to the monomer feed composition and the reactivity ratios of the monomers, the copolymer composition was calculated from the copolymer composition equation. It should 1% of HY6CN-ICTO (weight). However, the copolymer is actually a mixture of PS-co-HY6CN-ICTO copolymners with different copolymer compositions. With the increase of the conversion during the polymerization, the more reactive monomer HY2MA was consumed. This results in a continual shift of the monomer feed composition to lower HY6CN-ICTO content, and also a continual shift in copolymer composition. The calculated copolymer composition can only be obtained at low conversions of polymerization (<10%) where the compositional drift is negligible.

### Example 10

### Synthesis of PU-co-Napht-3CN-IC6 Copolymer

1—Copolymerization

A mixture of 50 parts of hexamethylenediamine and 250 parts of water in presence of 5 parts of dispersing agent is firstly heated and kept at 80° C. Napht-3CN-IC6 monomer (of example 5) bright red solution is then added to this solution under vigorous stirring, over 1 hour at this temperature. Immediately after addition begins, a bright red-orange product starts to precipitate. After end of addition, the red suspension is stirred at 80° C. for 3 additional hours.

2—Purification

The precipitate was filtered and washed with hot water until no alkyldiamine is detectable in filtrate. Resulting presscake is suction-dried on Büchner. Presence of unreacted dye is checked in various organic solvents. No free dye was extractable from copolymer. The red-orange powder was then dried in a vacuum oven at 80° C. overnight.

3—Properties

Shape and color:40 g of bright red-orange powder

Solubility:partially soluble in the following organic solvents:methanol, acetone, DMF, NMP, DMSO, chloroform, dichlorobenzene.

DSC:peaks at 256° C., 371° C. and 465° C.

Composition:according to the monomer feed composition and the reactivity ratios of the monomers, the copolymer composition was calculated from the copolymer composition equation. It should contain 1% of Napht-3CN-IC6 (weight). However, the copolymer is actually a mixture of PU-co-Napht-3CN-IC6 copolymers with different copolymer compositions. With the increase of the conversion during the polymerization, the more reactive monomer Napht-3CN-IC6 was consumed. This results in a continual shift of the monomer feed composition to lower Napht-3CN-IC6 content, and also a continual shift in copolymer composition. The calculated copolymer composition can only be obtained at low conversions of polymerization (<10%) where the compositional drift is negligible.

1. A dye monomer of the general formula (I) 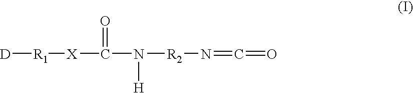
with R₁ is C₁₋₁₂ alkylen, C₆₋₁₀ arylen, (C₆₋₁₀) aryl-(C₁₋₆) alkylen or (C₁₋₆) alkyl-(C₆₋₁₀) arylen, —(C₁₋₆alkylen-O—)ₙ—C₁₋₆alkylen- with n being a number from 0 to 6;
X is oxygen or NR′ with R′ being hydrogen, C₁₋₆ alkyl, C₆₋₁₀ aryl, (C₆₋₁₀) aryl-(C₁₋₆) alkyl or (C₁₋₆) alkyl-(C₆₋₁₀) aryl,
R₂ is C₁₋₁₂ alkylen, C₅₋₆ cycloakylen, C₆₋₁₀ arylen, (C₆₋₁₀) aryl-(C₁₋₆) alkylen or (C₁₋₆) alkyl-(C₆₋₁₀) arylen, —(C₁₋₆alkylen-O—)ₙ—C₁₋₆alkylen- with n being a number from 0 to 6;
D is a dye moiety being of the general formula (II), (III), (IV), (V) or (VI) 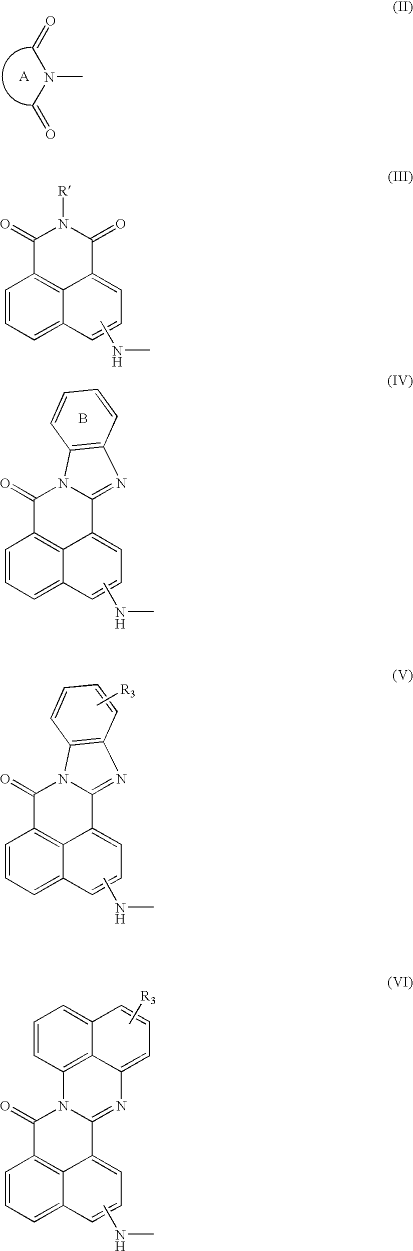
with A being a substituted or unsubstituted fused aromatic or heterocyclic ring system,
R₃ being hydrogen, halogen, NR₄R₅, R₅O or R₅S, with R₄ being hydrogen, C₁₋₆ alkyl, C₆₋₁₀ aryl, (C₆₋₁₀) aryl-(C₁₋₆) alkyl or (C₁₋₆) alkyl-(C₆₋₁₀) aryl, R₅ being C₁₋₆ alkyl, C₆₋₁₀ aryl, (C₆₋₁₀) aryl-(C₁₋₆) alkyl or (C₁₋₆) alkyl-(C₆₋₁₀) aryl; and
Ring B being annelated in 3,4-position with a group of the formula —NR₆(CO)ₘ—NR₇— or —O—CO—NR₆—, wherein m is 1 or 2, R₆ and R₇ are independently hydrogen, C₁₋₆ alkyl, C₆₋₁₀ aryl, (C₆₋₁₀) aryl-(C₁₋₆)alkyl or (C₁₋₆)alkyl-(C₆₋₁₀)aryl, and
R′ being defined as above.

2. A dye monomer according to claim 1, wherein A is of the general formula (IIa), (IIb) or (IIc) 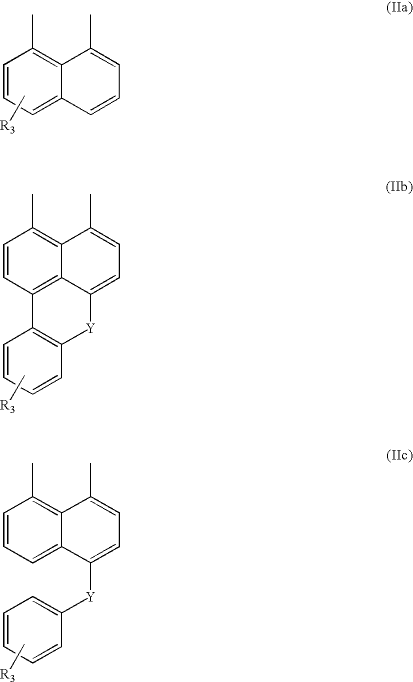
wherein R₃ is defined as in claim 1, and
Y is sulphur, oxygen or NR₄, with R₄ having the meaning given in claim 1.

3. A dye monomer according to claim 1, wherein R₁ and R₂ have a chain length of C₂₋₆.

4. A process for the preparation of a dye monomer according to claim 1, comprising the step of reacting a hydroxy or amino functionalized dye moiety with a diisocyanate moiety according to the general formula (VIII) 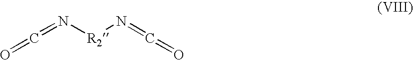
wherein R₂″ is C₁₋₁₂ alkylen, C₅₋₆ cycloakylen, C₆₋₁₀ arylen, (C₆₋₁₀) aryl-(C₁₋₆) alkylen or (C₁₋₆) alkyl-(C₆₋₁₀) arylen, —(C₁₋₆alkylen-O—)ₙ—C₁₋₆alkylen- with n being a number from 0 to 6.

5. A process for the preparation of a dye monomer according to claim 4 wherein the diisocyanate moiety (VIII) is a C₆₋₁₂ alkylendiisocyanate, toluylene-2,4-diisocyanate or 1-isocyanato-3-isocyanatoomethyl-3,5,5-trimethyl-cyclohexane.

6. A copolymer composition comprising a dye monomer according to claim 1.

7. A copolymer composition according to claim 6 further comprising at least one co-monomer selected from the group consisting of a diamine, a diol and a second diisocyanate compound.

8. A copolymer composition according to claim 7 wherein the diamine has the general formula (IX)
H₂N—R₂′—NH₂ (IX)
the diol has the general formula (XIV)
HO—R₂′—OH (XIV)
and the diisocyanate has the general formula (VIII) 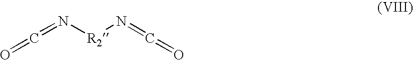
wherein R₂′ is C₁₋₁₂ alkylen, C₅₋₆ cycloakylen, C₆₋₁₀ arylen, (C₆₋₁₀) aryl-(C₁₋₆) alkylen or (C₁₋₆) alkyl-(C₆₋₁₀) arylen, —(C₁₋₆alkylen-O—)ₙ—C₁₋₆alkylen- with n being a number from 0 to 6.

9. A copolymer composition according to claim 6, wherein the content of the dye monomer in the copolymer composition is between 0.01 and 10 percent by weight.

10. A process for the preparation of a copolymer composition according to claim 6 comprising the steps of mixing at least one dye monomer according to claim 1 with at least one compound selected from the group consisting of a diamine diol and a second diisocyanate compound to form a mixture and reacting the mixture.

11. Copolymer particles having pigment like properties made by a process comprising the step of copolymerizing a dye monomer of claim 1 with copolymerizable monomers.

12. Copolymer particles according to claim 11 wherein the copolymerizing step further comprises suspension polymerizing at least one dye monomer according to claim 1 with at least one compound selected from the group consisting of a diamine a diol and a second diisocyanate compound.

13. Pigmented paper comprising the copolymer particles according to claim 11.

14. A dye monomer according to claim 1, wherein the alkylen and/or arylen radicals of R₁ are substituted by hydroxyl, C₁₋₆ alkyl, C₁₋₆ alkoxyl, C₆₋₁₀ aryloxy or halogen.

15. A dye monomer according to claim 1, wherein the alkyl and/or aryl radicals of R′ are substituted by hydroxyl, C₁₋₆ alkoxyl, C₆₋₁₀ aryloxy or halogen.

16. A dye monomer according to claim 1, wherein the alkylen, cycloalkylene and/or arylen radicals of R₂ are substituted by hydroxyl, C₁₋₆ alkyl, C₁₋₆ alkoxyl, C₆₋₁₀ aryloxy or halogen.

17. A dye monomer according to claim 1, wherein the alkyl and/or aryl radicals of R₄ and R₅ being substituted by hydroxyl, C₁₋₆ alkoxyl, C₆₋₁₀ aryloxy or halogen.

18. A dye monomer according to claim 1, wherein the alkyl and/or aryl radicals of R₆ and R₇ are substituted by amino, C₁₋₆ alkylamino, C₆₋₁₀ cycloalkylamino, hydroxyl, C₁₋₆ alkoxyl, C₆₋₁₀ aryloxy or halogen.

19. A dye monomer according to claim 1, wherein R₁ and R₂ have a chain length of C₂ or C₆.

20. The process according to claim 4, wherein the alkylen, cycloalkylene and/or arylen radicals of R″ are substituted by hydroxyl, C₁₋₆ alkyl, C₁₋₆ alkoxyl, C₆₋₁₀ aryloxy or halogen.

21. A copolymer composition according to claim 6, wherein the content of the dye monomer in the copolymer composition is between 1 and 3 percent by weight.

22. The copolymer composition according to claim 8, wherein the alkylen, cycloalkylene and/or arylen radicals of R₂′ are substituted by hydroxyl, C₁₋₆ alkyl, C₁₋₆ alkoxyl, C₆₋₁₀ aryloxy or halogen.

23. A synthetic polymer comprising copolymer particles according to claim 11.

24. A textile comprising copolymer particles according to claim 11.

25. A powder coating material comprising copolymer particles according to claim 11.

26. An electrophotographic toner or developer comprising copolymer particles according to claim 11.

27. An ink comprising copolymer particles according to claim 11, wherein the ink is a printing ink or an inkjet ink.
